(19) United States
(12) Patent Application Publication
(10) Pub. No.: US 2017/0034288 A1
(43) Pub. Date: Feb. 2, 2017

(54) ELECTRONIC APPARATUS, SYSTEM, AND INFORMATION NOTIFICATION METHOD

(71) Applicant: Seiko Epson Corporation, Tokyo (JP)

(72) Inventor: Michio Nakadaira, Shiojiri-shi (JP)

(21) Appl. No.: 15/211,485

(22) Filed: Jul. 15, 2016

(30) Foreign Application Priority Data
Jul. 31, 2015 (JP) 2015-152167

(51) Int. Cl. H04L 29/08; G01C 21/36; H04W 4/00

(52) U.S. Cl. CPC H04L 67/18; H04W 4/008; G01C 21/3691; G01C 21/3664

(57) ABSTRACT

An electronic apparatus is carried by a user and includes a receiver that receives, during the period for which the user is traveling along a route determined in advance, actually measured data acquired by electronic apparatus of information providers who are traveling along the route and a notifier that notifies the user of information on the route on the basis of the received actually measured data.

### CROSS-REFERENCE

This application claims priority to Japanese Patent Application No. 2015-152167, filed Jul. 31, 2015, the entirety of which is hereby incorporated by reference.

### BACKGROUND

1. Technical Field

The present invention relates to an electronic apparatus, a system, an information notification method, and an information notification program.

2. Related Art

A mountain climber desires to grasp the latest situation of a route along which the mountain climber plans to climb a mountain. The latest situation of a mountain climbing route includes the weather conditions along the route, the surface condition of the route, and other factors. To fulfil the desire, an Internet site carrying a large number of reports which have been uploaded by general mountain climbers and to which photographs are attached has been created.

However, since there is a time lag from the day of mountain climbing to the day when a report on the mountain climbing is uploaded, and the time lag typically ranges from about one day to several days, the information gets old and does not help mountain climbing on another day in many cases.

As another way to fulfil the desire, there has been a proposed server that receives the weather, humidity/temperature, wind direction, wind speed, and other pieces of information around a mountain lodge from a terminal in the mountain lodge, edits the received information into information in a form suitable for mountain climbers, and distributes the information to the public (see JP-A-2004-13478).

However, since the information collectable from the server is limited to information around the mountain lodge, the information has not necessarily been effectively used depending on the action of a mountain climber on the day of mountain climbing.

### SUMMARY

An advantage of some aspects of the invention is to provide an electronic apparatus, a system, an information notification method, and an information notification program capable of providing information meaningful to a user who plans to travel along a route determined in advance.

The invention can be implemented in the form of the following aspects or application examples.

### APPLICATION EXAMPLE 1

An electronic apparatus according to this application example is an electronic apparatus carried by a user and including a receiver that receives, during a period for which the user is traveling along a route determined in advance, actually measured data acquired by electronic apparatus of information providers who are traveling along the route and a notifier that notifies the user of information on the route on the basis of the plurality of sets of received actually measured data.

That is, the receiver collects the actually measured data on the route during the period for which the user is traveling along the route. The source from which the actually measured data is provided is the electronic apparatus of the information providers who are traveling along the route. It is therefore highly probable that a recent situation (including current situation) on the route has been reflected in the actually measured data. It is therefore considered that the notifier can notify the user of the recent situation (including current situation) of the route as the information on the route.

### APPLICATION EXAMPLE 2

The electronic apparatus according to the application example may further include a measurement device that performs measurement during the period, a processor that uses results of the measurement performed by the measurement device to generate the actually measured data, and a transmitter that transmits the generated actually measured data during the period to an apparatus external to the electronic apparatus carried by the user.

That is, the measurement device and the processor generate the actually measured data, and a transmitter transmits the actually measured data to an external apparatus. The electronic apparatus can therefore, for example, share the actually measured data with another electronic apparatus.

### APPLICATION EXAMPLE 3

In the electronic apparatus according to the application example, the transmitter may transmit the generated actually measured data and the received actually measured data.

That is, the transmitter transmits not only the internally generated actually measured data but also the received actually measured data to an external apparatus. The electronic apparatus can therefore transmit actually measured data from a plurality of electronic apparatus to another electronic apparatus.

### APPLICATION EXAMPLE 4

In the electronic apparatus according to the application example, the actually measured data may contain data representing atmospheric pressure, and the information on the route may contain information on atmospheric pressure at two or more points.

That is, the notifier notifies the user of the atmospheric pressure at the two or more points on the basis of the data representing the atmospheric pressure. The user can therefore grasp, for example, a rough weather condition on the route.

### APPLICATION EXAMPLE 5

In the electronic apparatus according to the application example, the actually measured data may contain data representing points where troubles have occurred, and the information on the route may contain information on trouble occurrence frequency distribution.

That is, the notifier notifies the user of the trouble occurrence frequency distribution on the basis of the data representing points where troubles have occurred. The user can therefore predict a rough situation at each point on the route, for example, whether or not the route is easily passable.

### APPLICATION EXAMPLE 6

In the electronic apparatus according to the application example, the actually measured data may contain data representing the information providers' movement locus, and the information on the route may contain information on frequency of use of at least a partial segment of the route.

That is, the notifier notifies the user of the frequency of use of at least a partial segment of the route on the basis of the data on the route used for travel. The user can therefore learn, for example, the popularity of the notified segment of the route.

### APPLICATION EXAMPLE 7

In the electronic apparatus according to the application example, the actually measured data may contain data representing points where the information providers were present, and the information on the route may contain information on congestion degree distribution.

That is, the notifier notifies the user of the congestion degree distribution on the basis of data on the points where the information providers were present. The user can therefore learn the degree of congestion at each point on the route.

### APPLICATION EXAMPLE 8

In the electronic apparatus according to the application example, the actually measured data may contain data representing the information providers' movement locus, and the information on the route may contain information on a specific information provider's movement locus.

The notifier therefore notifies the user of the specific information provider's movement locus on the basis of the data on the movement locus. The user can therefore grasp the specific information provider's action.

### APPLICATION EXAMPLE 9

In the electronic apparatus according to the application example, the distance over which the receiver can receive the actually measured data may be roughly equal to a communication distance in short-distance wireless communication.

That is, when the user who carries the electronic apparatus and an information provider so approach each other on the route as to be close enough to allow short-distance wireless communication, the receiver performs reception. The occurrence of a situation in which a large amount of information that does not relate to the route along which the user is traveling is undesirably collected along with necessary information can therefore be suppressed, unlike a case where long-distance communication and other types of communication are performed.

### APPLICATION EXAMPLE 10

The electronic apparatus according to the application example may be attachable to the user's predetermined site.

The user can therefore perform a sports activity in a hands-free state.

### APPLICATION EXAMPLE 11

In the electronic apparatus according to the application example, the predetermined site may be an arm or a wrist.

The user can therefore use the electronic apparatus as if it were, for example, a wristwatch.

### APPLICATION EXAMPLE 12

A system according to this application example is a system including a first electronic apparatus carried by a first user and a second electronic apparatus carried by a second user, the first electronic apparatus including a measurement device that performs measurement during a period for which the first user is traveling along a route determined in advance, a processor that uses results of the measurement performed by the measurement device to generate actually measured data, and a transmitter that transmits the generated actually measured data during the period to an apparatus external to the first electronic apparatus, and the second electronic apparatus including a receiver that receives the actually measured data transmitted from the first electronic apparatus during a period for which the second user is traveling along the route and a notifier that notifies the second user of information on the route on the basis of the received actually measured data.

Therefore, according to the system of this application example, information can be shared between the first user and the second user who carry the electronic apparatus and travel along the same route.

### APPLICATION EXAMPLE 13

An information notification method according to this application example is a method carried out by an electronic apparatus carried by a user, the method including receiving, during a period for which the user is traveling along a route determined in advance, actually measured data acquired by electronic apparatus of information providers who are traveling along the route and notifying the user of information on the route on the basis of the plurality of sets of received actually measured data.

That is, in the information notification method according to this application example, the actually measured data on the route is received during the period for which the user is traveling along the route. The source from which the actually measured data is provided is the electronic apparatus of the information providers who are traveling along the route. It is therefore highly probable that a recent situation (including current situation) on the route has been reflected in the actually measured data. It is therefore considered that the recent situation (including current situation) of the route can be notified as the information on the route to the user.

### APPLICATION EXAMPLE 14

An information notification program according to this application example is a program executed by a computer of an electronic apparatus carried by a user, the program causing the computer to receive, during a period for which the user is traveling along a route determined in advance, actually measured data acquired by electronic apparatus of information providers who are traveling along the route and notify the user of information on the route on the basis of the plurality of sets of received actually measured data.

That is, the computer receives the actually measured data on the route during the period for which the user is traveling along the route. The source from which the actually measured data is provided is the electronic apparatus of the information providers who are traveling along the route. It is therefore highly probable that a recent situation (including current situation) on the route has been reflected in the actually measured data. It is therefore considered that the recent situation (including current situation) of the route can be notified as the information on the route to the user.

### BRIEF DESCRIPTION OF THE DRAWINGS

The invention will be described with reference to the accompanying drawings, wherein like numbers reference like elements.

FIG. 1 describes an overview of an electronic apparatus according to a first embodiment.

FIG. 2 is a functional block diagram for describing an example of the configuration of a system including two or more electronic apparatus.

FIG. 3 describes an example of routes contained in mountain climbing plan data.

FIG. 4 describes an example of the configuration of the mountain climbing plan data.

FIG. 5 describes an example of mountain climbing log data.

FIG. 6 is a flowchart for describing an example of an information collection process.

FIG. 7 is a flowchart for describing an example of a logging process.

FIG. 8 is a flowchart for describing an example of a display process.

FIG. 9 is a flowchart for describing an example of an atmospheric pressure display mode process.

FIG. 10 describes an example of a display screen in the atmospheric pressure display mode.

FIG. 11 is a flowchart for describing an example of a trouble display mode process.

FIG. 12 describes an example of a display screen in the trouble display mode.

FIG. 13 is a flowchart for describing an example of a popular route display mode process.

FIG. 14 describes an example of a display screen in the popular route display mode.

FIG. 15 is a flowchart for describing an example of a congestion degree display mode process.

FIG. 16 describes an example of a display screen in the congestion degree display mode.

FIG. 17 is a flowchart for describing an example of an acquaintance display mode process.

FIG. 18 describes an example of a display screen in the acquaintance display mode.

### DESCRIPTION OF EXEMPLARY EMBODIMENTS

Preferable embodiments of the invention will be described below in detail with reference to the drawings. The embodiments described below are not intended to unduly limit the contents of the invention set forth in the appended claims. Further, all configurations described below are not necessarily essential configuration requirements of the invention.

### 1. Embodiment of Electronic Apparatus

### 1-1. Overview of Electronic Apparatus

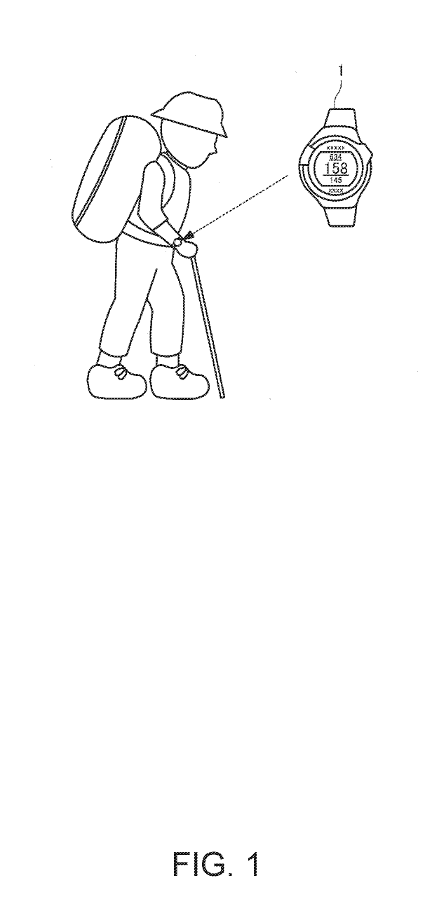

FIG. 1 describes an overview of an electronic apparatus 1 in a first embodiment.

The electronic apparatus 1 (example of second electronic apparatus) in the present embodiment is, for example, a mobile information apparatus attached to part of a user's (example of user, example of second user) body in an outdoor activity, such as mountain climbing, as shown in FIG. 1. The body part to which the electronic apparatus 1 is attached is, for example, a site in any position from the elbow to the hand (forearm) so that the electronic apparatus 1 is visible to the user whenever necessary. In the example shown in FIG. 1, the electronic apparatus 1 is configured as a wrist-worn-type (wristwatch-type) mobile information apparatus (outdoor watch), and the body part to which the electronic apparatus 1 is attached is the wrist.

The electronic apparatus 1 has a clock function as well as a positioning function, a compass function, an atmospheric pressure detection function, a pulse detection function, and a variety of other sensing functions, and a communication function. The following description will be made on the assumption that the electronic apparatus 1 is used in mountain climbing.

The electronic apparatus 1 uses the sensing functions to perform logging associated with the user's activity (mountain climbing in the description). The term “logging” used herein refers to time-course recording (that is, acquiring histories) of quantities representing at least part of the user's activity, for example, the latitude, longitude, altitude, velocity, direction, atmospheric pressure, heart rate per unit time, the number of steps per unit time, body temperature, air temperature, sweat rate, humidity, the amount of ultraviolet rays per unit time, and a variety of other sensed data. Data acquired in logging associated with mountain climbing is hereinafter referred to as “mountain climbing log data.”

The electronic apparatus 1 uses the communication function to collect the mountain climbing log data associated with other users (example of information providers, example of first user). Specifically, the electronic apparatus 1 carries out the process of collecting the mountain climbing log data associated with a plurality of users (information collection process) by communicating with other electronic apparatus (example of first electronic apparatus, hereinafter simply referred to as “other electronic apparatus”) carried by other users and communicating with a network server to generate information meaningful to the user of the electronic apparatus 1 (statistical information).

On the day of mountain climbing, the user carries the electronic apparatus 1 and allows the electronic apparatus 1 to initiate the information collection process by inputting an initiation instruction to the electronic apparatus 1, for example, at the point of departure of a mountain climbing route. Further, the user allows the electronic apparatus 1 to terminate the information collection process by inputting a termination instruction to the electronic apparatus 1, for example, at the destination of the route.

The user can disable the communication function of the electronic apparatus 1 as required. For example, the user can turn on and off the communication function of allowing the electronic apparatus 1 to communicate with other electronic apparatus and can further turn on and off, independent of the above communication function, the communication function of allowing the electronic apparatus 1 to communicate with a network server (network connection function). It is assumed in the following description that these communication functions are both turned on. In this case, the electronic apparatus 1 collects the mountain climbing log data associated with other users without forcing the user to be particularly aware of the data collection.

Further the user can switch a display mode of the electronic apparatus 1 as required. The display mode of the electronic apparatus 1 includes an atmospheric pressure display mode in which information extracted from the mountain climbing log data associated with a plurality of users (such as statistical information on route), a trouble display mode, a popular route display mode, a congestion degree display mode, and an acquaintance display mode. Each of the five display modes will be described later in detail.

### 1-2. Configuration of System

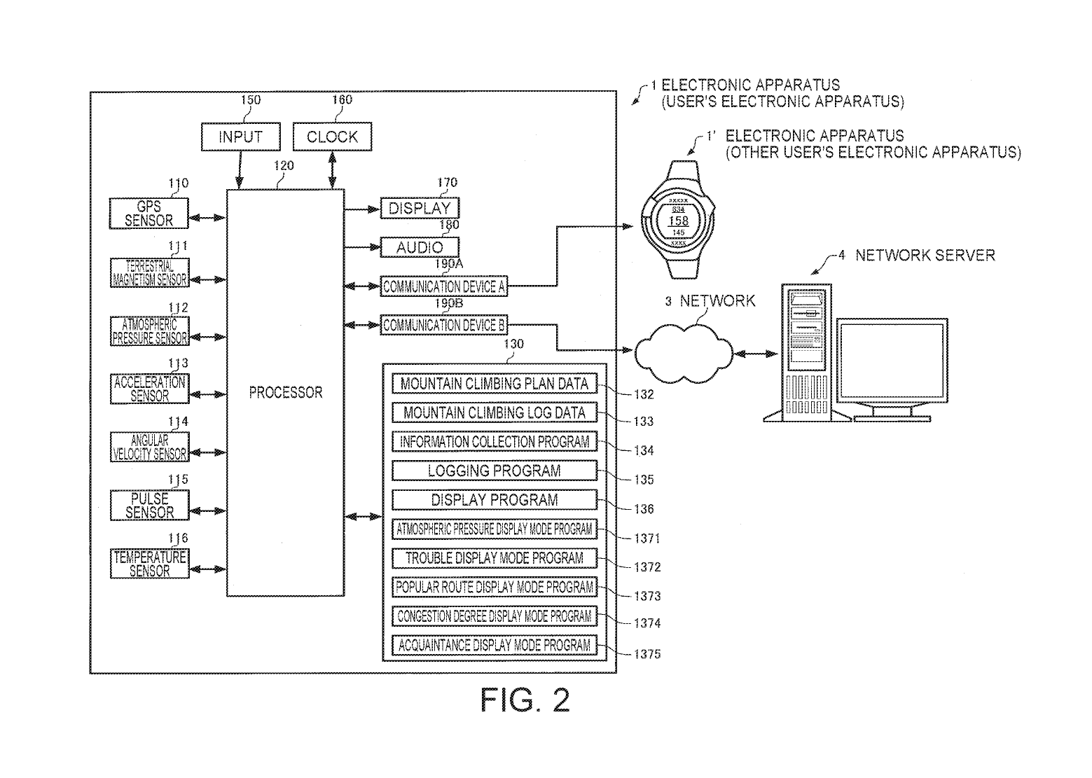

FIG. 2 is a functional block diagram for describing the configuration of a system including two or more electronic apparatus.

The electronic apparatus 1 carried by the user can communicate with other electronic apparatus 1′ carried by other users, and the electronic apparatus 1 carried by the user can communicate with a network server 4 via a network 3, as shown in FIG. 2.

The electronic apparatus 1 includes a GPS sensor (example of measurement device) 110, a terrestrial magnetism sensor (example of measurement device) 111, an atmospheric pressure sensor (example of measurement device) 112, an acceleration sensor (example of measurement device) 113, an angular velocity sensor (example of measurement device) 114, a pulse sensor (example of measurement device) 115, a temperature sensor (example of measurement device) 116, a processor 120, a memory 130, an input 150, a clock 160, a display (example of notifier) 170, an audio (example of notifier) 180, a communication device (example of receiver or transmitter) 190A, a communication device (example of receiver or transmitter) 190B, and other components. In the configuration of the electronic apparatus 1, however, part of the constituent elements described above may be omitted or changed, or another constituent element (humidity sensor, ultraviolet ray sensor, for example) may be added.

The GPS sensor 110 is a sensor that produces positioning data (such as latitude, longitude, altitude, and other position coordinates, and velocity vector) representing the position and other factors of the electronic apparatus 1 and outputs the positioning data to the processor 120, and the GPS sensor 110 includes, for example, a GPS receiver (GPS: global positioning system) and other components. The GPS sensor 110 receives an externally incoming electromagnetic wave that belongs to a predetermined frequency band via a GPS antenna that is not shown, extracts a GPS signal from a GPS satellite, and produces the positioning data representing the position and other factors of the electronic apparatus 1 on the basis of the GPS signal.

The terrestrial magnetism sensor 111 is a sensor that detects a terrestrial magnetism vector representing the terrestrial magnetic field direction viewed from the electronic apparatus 1 and produces, for example, terrestrial magnetism data representing magnetic flux densities in three axial directions perpendicular to each other. The terrestrial magnetism sensor 111 is, for example, an MR (magnet resistive) element, an MI (magnet impedance) element, or a Hall element.

The atmospheric pressure sensor 112 is a sensor that detects the surrounding atmospheric pressure (barometric pressure) and has, for example, a pressure sensitive element operating on the basis of a method using a change in the resonance frequency of a vibrating piece (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator. The output from the atmospheric pressure sensor 112 (atmospheric pressure data) (example of data representing atmospheric pressure) may be used to correct positional information contained in the positioning data.

The acceleration sensor 113 is an inertia sensor that detects acceleration in each of three axial directions that intersect each other (ideally perpendicular to each other) and outputs a digital signal according to the magnitude and direction of the detected acceleration in each of the three axes (acceleration data). The output from the acceleration sensor 113 (acceleration data) may be used to correct the positional information contained in the positioning data.

The angular velocity sensor 114 is an inertia sensor that detects angular velocity in each of the three axial directions that intersect each other (ideally perpendicular to each other) and outputs a digital signal according to the magnitude and direction of the measured angular velocity in each of the three axes (angular velocity data). The output from the angular velocity sensor 114 (angular velocity data) may be used to correct the positional information contained in the positioning data.

The pulse sensor 115 is a sensor that produces a signal representing the user's pulse and outputs the signal to the processor 120. The pulse sensor 115 includes, for example, an LED light source or any other light source that emits measurement light having an appropriate wavelength toward a subcutaneous blood vessel and a light receiving device that detects a change in the intensity of light produced at the blood vessel in response to the measurement light. The output from the pulse sensor 115 is hereinafter referred to as “pulse data.”

The temperature sensor 116 is a temperature sensitive element that outputs a signal according to the surrounding temperature (voltage according to temperature, for example). The temperature sensor 116 may instead be a sensor that outputs a digital signal according to the temperature. The output from the temperature sensor 116 is hereinafter referred to as “temperature data.”

The processor 120 is formed, for example, of an MPU (micro processing unit), a DSP (digital signal processor), and an ASIC (application specific integrated circuit). The processor 120 carries out a variety of processes in accordance with a program stored in the memory 130 and a variety of commands inputted by the user via the input 150. The processes carried out by the processor 120 include data processing in which data outputted by the GPS sensor 110, the terrestrial magnetism sensor 111, the atmospheric pressure sensor 112, the acceleration sensor 113, the angular velocity sensor 114, the pulse sensor 115, the temperature sensor 116, the clock 160, and other components are processed, display processing in which the display 170 is caused to display an image, audio processing in which the audio 180 is caused to output audio, and other types of processing. The processor 120 in the present embodiment carries out the process of creating log data related to a serial ID, time, a variety of sensed data, and a trouble flag, which will be described later, and other pieces of information, the process of writing the log data to mountain climbing log data 133 (which will be described later) in the memory 130, and other processes.

The memory 130 is formed, for example, of one or more IC memories and has a ROM that memorizes programs and other data and a RAM that serves as a work area used by the processor 120. The RAM includes a nonvolatile RAM, and the nonvolatile RAM provides a memory area, where mountain climbing plan data 132, the mountain climbing log data 133, and other data are memorized. The programs memorized in the ROM (example of information notification program) include an information collection program 134, a logging program 135, a display program 136, an atmospheric pressure display mode program 1371, a trouble display mode program 1372, a popular route display mode program 1373, a congestion degree display mode program 1374, an acquaintance display mode program 1375, and other programs.

The input 150 is formed, for example, of buttons, keys, a microphone, a touch panel, a voice recognition function (using microphone that is not shown), and an action detection function (using acceleration sensor 113 or any other sensor), converts a variety of types of operation (action) of the user into appropriate signals, and transmits the signals to the processor 120.

The clock 160 is formed, for example, of a real-time clock (RTC) IC, produces time data, such as the year, month, date, hour, minute, and second, and transmits the time data to the processor 120.

The display 170 is formed, for example, of an LCD (liquid crystal display), an organic EL (electroluminescence) display, an EPD (electrophoretic display), or a touch-panel-type display and displays a variety of images in accordance with an instruction from the processor 120.

The audio 180 is formed, for example, of a loudspeaker, a buzzer, or a vibrator and produces a variety of types of audio (or vibration) in accordance with an instruction from the processor 120.

The communication device 190A performs a variety of types of control for performing wireless data communication with an external apparatus (such as another electronic apparatus 1′ and information terminal) located close (within several meters, for example) to the electronic apparatus 1. The communication device 190A includes a transceiver that complies, for example, with Bluetooth (registered trademark) (including BTLE: Bluetooth Low Energy), Wi-Fi (registered trademark) (Wi-Fi: Wireless Fidelity), Zigbee (registered trademark), NFC (Near Field Communication), ANT+ (registered trademark), and other short-distance wireless communication standards.

The communication device 190B performs a variety of types of control for performing wireless data communication with the network server 4 via the network 3, for example, a mobile phone communication network and the Internet. The communicatable distance of the communication device 190B (example of distance over which receiver can receive actually measured data) is longer than the communicatable distance of the communication device 190A, for example, is roughly equal to the communicatable distance of a mobile terminal connectable to a mobile phone communication network.

The configuration of the other electronic apparatus 1′ is basically the same as the configuration of the electronic apparatus 1. Therefore, when the other electronic apparatus 1′ approaches the electronic apparatus 1 to a point where they are close to each other (within several meters), the other electronic apparatus 1′ can communicate with the electronic apparatus 1. The communicatable distance between the electronic apparatus 1 and the other electronic apparatus 1′ (that is, communicatable distance of communication device 190A) is, for example, roughly equal to the communicatable distance in short-distance wireless communication and is further roughly equal to the distance between an ascending mountain climber and a descending mountain climber who pass by each other on a mountain climbing route. Therefore, when the user who carries the electronic apparatus 1 and another user who carries the other electronic apparatus 1′ pass by each other during mountain climbing, the other electronic apparatus 1′ communicates with the electronic apparatus 1, whereas during a period for which they do not pass by each other, the other electronic apparatus 1′ does not communicate with the electronic apparatus 1.

The network server 4 is a server that provides the user who carries the electronic apparatus 1 and the other user who carries the other electronic apparatus 1′ with information. The network server 4 has built-in functions, such as the function of managing the mountain climbing log data and other pieces of information uploaded from the users on a user basis and the function of editing the mountain climbing log data uploaded from the users (sorting necessary log data out) and providing the users with the edited mountain climbing log data. The network server 4 further has a built-in function of providing the users with program data, map data, route data, and other pieces of data.

In FIG. 2, the number of other electronic apparatus 1′ is one, but the number may be two or more (including a large number). The closer users who carry other electronic apparatus 1′ are to one another in the same area, the higher the possibility of collection of the mountain climbing log data associated with many users into the electronic apparatus 1. The “area” used herein means an area to which a planned route and a reserve route that will be described later belong.

### 1-3. Mountain Climbing Plan Data

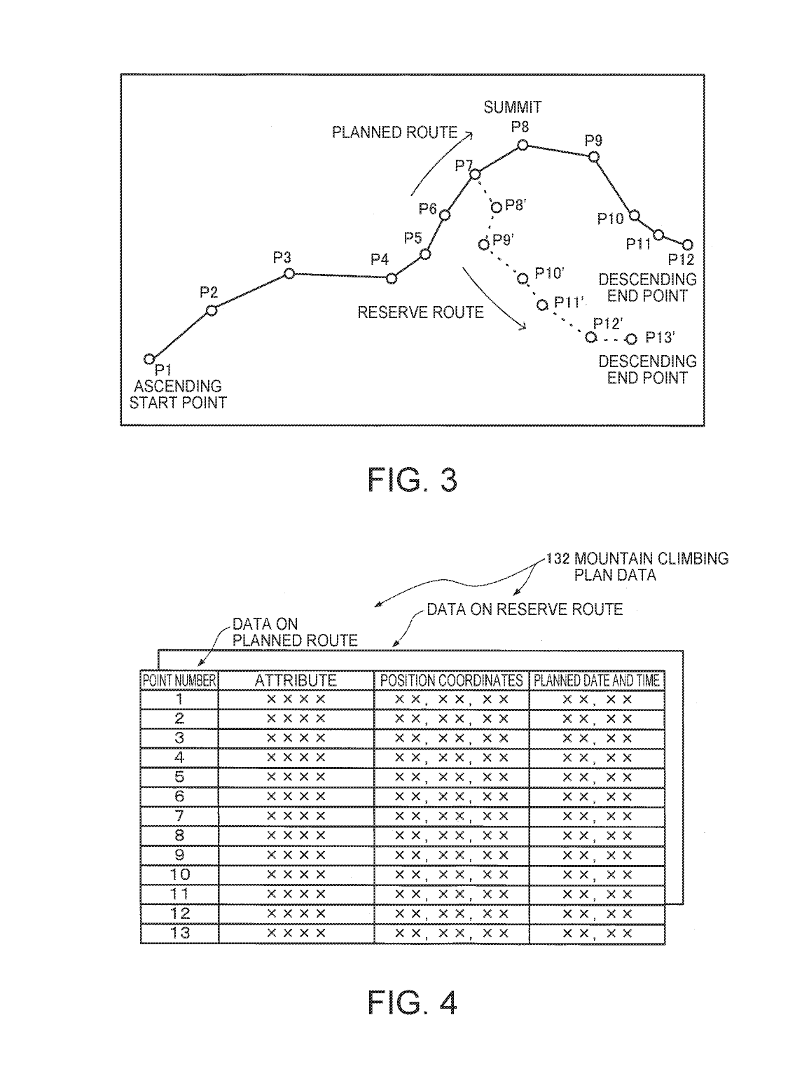

FIG. 3 describes an example of routes registered in the mountain climbing plan data 132, and FIG. 4 describes an example of the data configuration of the mountain climbing plan data 132.

In the mountain climbing plan data 132, a plurality of routes (example of routes determined in advance), for example, those shown in FIG. 3, are registered in advance. The plurality of routes include the user's planned route and the user's reserve route. The planned route is a route along which the user has planned to travel in the mountain climbing, and the reserve route is a route that is a candidate selected when the user changes the route in the course of the mountain climbing.

Each of the planned route and the reserve route is formed of an existing route that is typically used (or combinations of such routes). Each of the planned route and the reserve route is therefore likely to be used not only by the user but also other users. FIG. 3 shows only one reserve route, but the plurality of routes may include two or more reserve routes. When the user desires to increase the amount of information collected into the electronic apparatus 1, the number of reserve routes registered in the mountain climbing plan data 132 may be increased.

In the mountain climbing plan data 132, the data on each route is basically formed of data on the coordinates (latitude, longitude, and altitude) of the positions of points P1, P2, P3, . . . from the point of departure to the destination of the route, as shown in FIG. 4. Each of the “points” used herein means a position on the route. The “points” may include points where a user has planned to do some events (such as rest and lunch) (event points), may include a point where another route branches off, or may include any other point. The data on each of the points may contain data representing an attribute of the point, data on date and time when the user has planned to pass the point, and other data.

The registration of the plurality of routes in the mountain climbing plan data 132 can be performed in advance by the user, for example, via an information terminal (such as smartphone, tablet PC, and notebook PC) that can directly or indirectly communicate with the electronic apparatus 1. Data on each of the plurality of routes registered in the mountain climbing plan data 132 may, for example, be data made open to the public over a network, such as the Internet, or provided by the network server 4 to the user.

### 1-4. Mountain Climbing Log Data

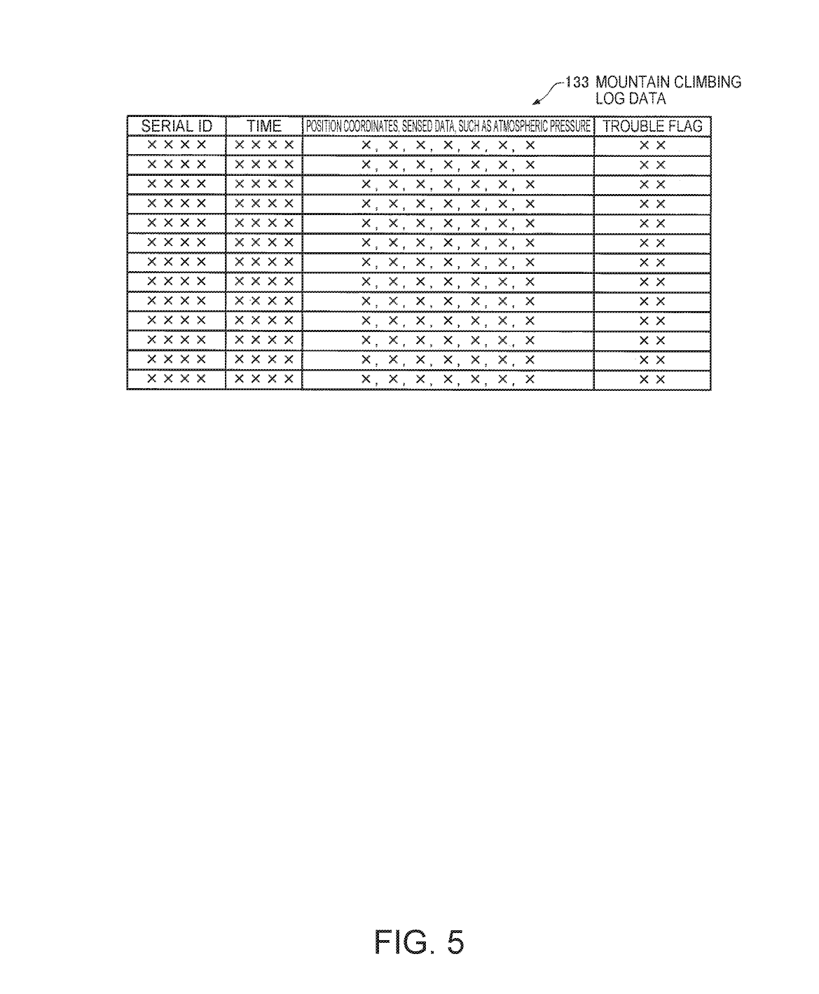

FIG. 5 describes the mountain climbing log data 133.

The mountain climbing log data 133 is formed of the position coordinates and a variety of sensed data, such as the atmospheric pressure, recorded on a time basis and a serial ID basis, as shown in FIG. 5. In the mountain climbing log data 133, a series of sensed data recorded at the same time and having the same serial ID are hereinafter simply referred to as “log data.” Further, the “time” used herein is assumed to include not only the hour and minute but also the year, month, date, second, and other pieces of information.

In the mountain climbing log data 133, the reason why the serial ID is given to individual log data (example of actually measured data) is that log data associated with two or more users are possibly written into the mountain climbing log data 133. The serial ID is, for example, the same as identification information for identifying the other electronic apparatus 1 having acquired the individual log data (that is, identifying user). The serial ID is, for example, assigned to the electronic apparatus 1 by the manufacturer thereof at the time of shipment and is typically used, when the electronic apparatus 1 communicates with the other electronic apparatus 1′, the network server 4, or any other apparatus, to allow the electronic apparatus 1 to be recognized by the communication counterpart.

The mountain climbing log data 133 is further used to notify the user of a point where a trouble has occurred. To this end, in the mountain climbing log data 133, a trouble flag (example of data representing a point where a trouble has occurred) is given to individual log data. The trouble flag is identification information representing whether or not the user of the electronic apparatus 1 that acquired the log data encountered some trouble (for example, trouble that forced user to change route) at the time when the log data was acquired.

### 1-5. Information Collection Process

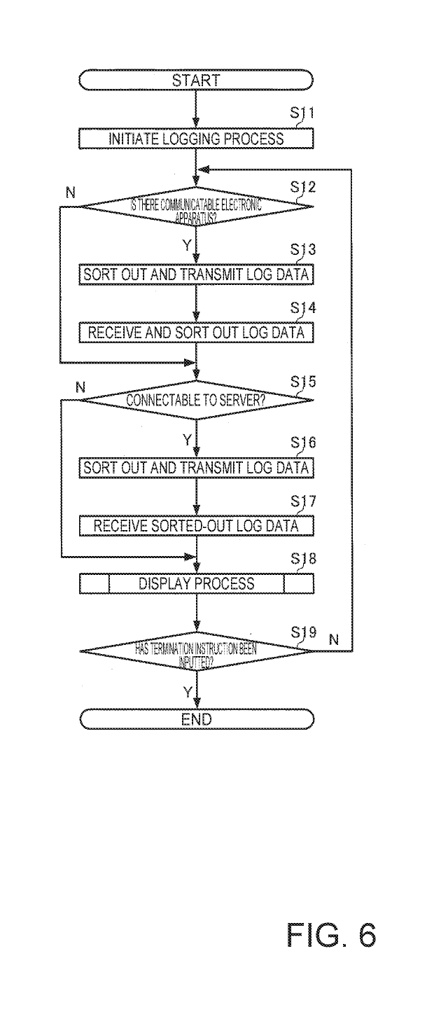

FIG. 6 is a flowchart for describing the information collection process carried out by the processor 120.

The information collection process (example of information notification method) is carried out in accordance with the information collection program 134. The timing at which the information collection process is initiated is, for example, the timing at which the user inputs an initiation instruction at the point of departure of the planned route, and the timing at which the information collection process is terminated is, for example, the timing at which the user inputs a termination instruction at the destination of the planned route. Each step of the information collection process will be sequentially described below.

Step S11: The processor 120 initiates a logging process. The logging process will be described later in detail.

Step S12: The processor 120 evaluates whether or not there is another electronic apparatus 1′ that can communicate with the electronic apparatus 1 via the communication device 190A. When a result of the evaluation shows that there is a communicatable electronic apparatus 1′ (Y in step S12), the processor 120 establishes communication with the electronic apparatus 1′ and proceeds to step S13, whereas when a result of the evaluation shows that there is no communicatable electronic apparatus 1′ (N in step S12), the processor proceeds to step S15.

Step S13: The processor 120 transmits one or more sets of log data stored in the mountain climbing log data 133 to the other electronic apparatus 1′ via the communication device 190A.

It is, however, noted that the processor 120 in the present step S13 excludes log data acquired at least a predetermined period (at least 24 hours, for example) before the current time from the log data to be transmitted.

Further, the processor 120 in the present step S13 excludes log data to which the same serial ID as the serial ID of the log-data-destination electronic apparatus 1′ is given from the log data to be transmitted.

Step S14: The processor 120 receives log data transmitted from the other electronic apparatus 1′ via the communication device 190A and writes the received log data into the mountain climbing log data 133.

The log data received by the electronic apparatus 1 is therefore newly written into the mountain climbing log data 133. The newly written log data possibly contains not only the log data acquired by the other electronic apparatus 1′ but also log data received by the other electronic apparatus 1′ from another electronic apparatus. The mountain climbing log data 133 therefore possibly accumulates log data associated with a large number of users (in a bucket-brigade manner).

When log data acquired at the same time and having the same serial ID as the log data to be written has been already stored in the mountain climbing log data 133, the processor 120 in the present step skips the writing of the log data.

Step S15: The processor 120 evaluates whether or not it can communicate with the network server 4 via the communication device 190B. When a result of the evaluation shows that the processor 120 can communicate with the network server 4 (Y in step S15), the processor 120 establishes communication with the network server 4 and proceeds to step S16, whereas when a result of the evaluation shows that the processor 120 cannot communicate with the network server 4 (N in step S15), the processor proceeds to step S18.

Step S16: The processor 120 transmits (uploads) data on the routes registered in the mountain climbing plan data 132, one or more sets of log data stored in the mountain climbing log data 133, and other pieces of information to the network server 4 via the communication device 190B.

It is, however, noted that when the data on the routes stored in the mountain climbing plan data 132 or the log data stored in the mountain climbing log data 133 contains data having been already uploaded, the processor 120 excludes the uploaded data from the log data to be transmitted.

Step S17: The processor 120 receives log data transmitted by the network server 4 via the communication device 190B and writes (downloads) the received log data into the mountain climbing log data 133.

It is, however, noted that when log data acquired at the same time and having the same serial ID as the log data to be written has been already stored in the mountain climbing log data 133, the processor 120 in the present step skips the writing of the log data.

New log data received by the electronic apparatus 1 is therefore written into the mountain climbing log data 133.

The log data transmitted from the network server 4 are log data uploaded in the past by a large number of users.

It is, however, noted that log data acquired at points remote from the user's routes (that is, routes registered in mountain climbing log data 133) by a predetermined distance (1 km, for example) are excluded from the log data to be transmitted from the network server 4.

Further, log data acquired at least a predetermined period (at least 24 hours, for example) before the current time are excluded from the log data to be transmitted from the network server 4.

That is, the network server 4 has the function of excluding log data unnecessary for the user who is traveling any of the user's routes (log data that do not relate to user's routes) from the log data to be transmitted, as in the case of the electronic apparatus 1.

Step S18: The processor 120 carries out a display process. The display process will be described later in detail.

Step S19: The processor 120 evaluates whether or not the user has inputted the termination instruction. When a result of the evaluation shows that the user has inputted the termination instruction (Y in step S19), the processor 120 terminates the information collection process, whereas when a result of the evaluation shows that the user has not inputted the termination instruction (N in step S19), the processor 120 proceeds to step S12.

### 1-5-1. Logging Process

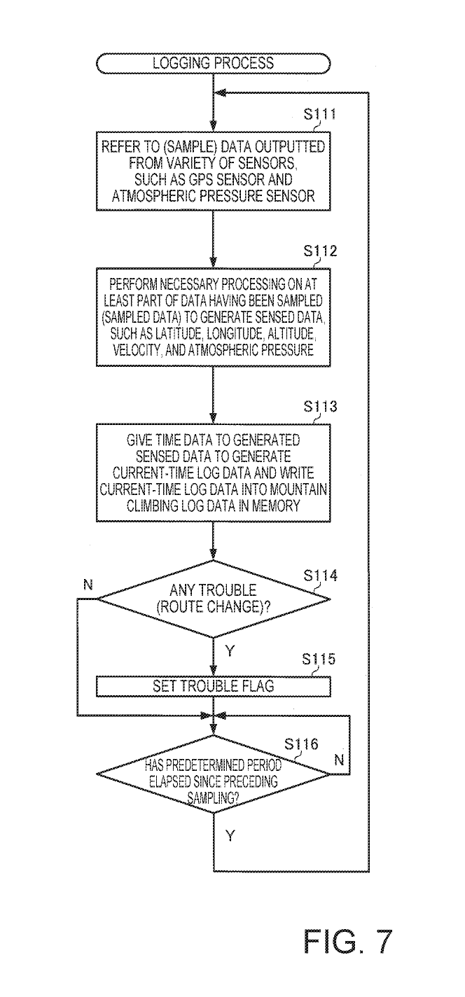

FIG. 7 is a flowchart for describing the logging process carried out by the processor 120. The logging process is carried out in accordance with the logging program 135. Each step of the logging process will be sequentially described below.

Step S111: The processor 120 refers to (samples) data outputted from the variety of sensors, such as the GPS sensor 110, the terrestrial magnetism sensor 111, the atmospheric pressure sensor 112, the acceleration sensor 113, the angular velocity sensor 114, the pulse sensor 115, and the temperature sensor 116.

Step S112: The processor 120 performs necessary processing on at least part of the data having been sampled (sampled data) to generate sensed data, such as the latitude, longitude, altitude, velocity, direction, atmospheric pressure, heart rate per unit time, the number of steps per unit time, and body temperature.

Step S113: The processor 120 gives data on the current time outputted from the clock 160 to the generated sensed data to generate current-time log data. The processor 120 then gives the serial ID of the electronic apparatus 1 to the current-time log data and writes the log data into the mountain climbing log data 133 in the memory 130.

Step S114: The processor 120 evaluates whether or not the user has changed the route in the period from the preceding sampling to the current sampling. When a result of the evaluation shows that the user has changed the route (Y in step S114), the processor 120 proceeds to step S115, whereas when a result of the evaluation shows that the user has not changed the route (N in step S114), the processor 120 proceeds to step S116.

For example, when the user inputs a route change notification (that is, notification of switching the travel route from planned route to reserve route) to the electronic apparatus 1 via the input 150 in the period described above, the processor 120 can determine on the basis of the notification input that the route has been changed.

Even when no notification is inputted, the processor 120 can calculate the path (hereinafter referred to as “movement locus”) of the coordinates (latitude, longitude, and altitude) of the positions of the user during the period described above, and when the amount of discrepancy between the movement locus and the planned route contained in the mountain climbing plan data 132 is greater than a predetermined threshold, the processor 120 can determine that the route has been changed in the period described above.

The movement locus is expressed, for example, by a zigzag line that chronologically connect the position coordinates at respective points of time or a curved line that approximates the zigzag line.

Step S115: The processor 120 sets the trouble flag in the log data written into the mountain climbing log data 133 in step S113 and then proceeds to step S116.

Step S116: The processor 120 evaluates whether or not a predetermined period (for example, 15 seconds, 30 seconds, 1 minute, 5 minute, or any other predetermined period) has elapsed since the timing at which the preceding step S111 was carried out. When a result of the evaluation shows that the predetermined period has elapsed (Y in step S116), the processor 120 proceeds to step S111, whereas when a result of the evaluation shows that the predetermined period has not elapsed (N in step S116), the processor 120 carries out step S116 again. Log data associated with the electronic apparatus 1 at each point of time is therefore gradually accumulated at the predetermined time intervals in the mountain climbing log data 133.

The log data written into the mountain climbing log data 133 are not limited to those described above. For example, the log data may be the sampled data itself resulting from the data from the variety of sensors (that is, non-processed data).

Further, when a signal outputted from at least part of the variety of sensors is an analog signal, the processor 120 may perform A/D conversion on the signal outputted from the part of the variety of sensors before the signal is sampled.

The order in which the steps in FIG. 7 are carried out can be changed as appropriate. For example, step S113 can be moved to the position after step S115 but before step S116.

### 1-5-2. Display Process

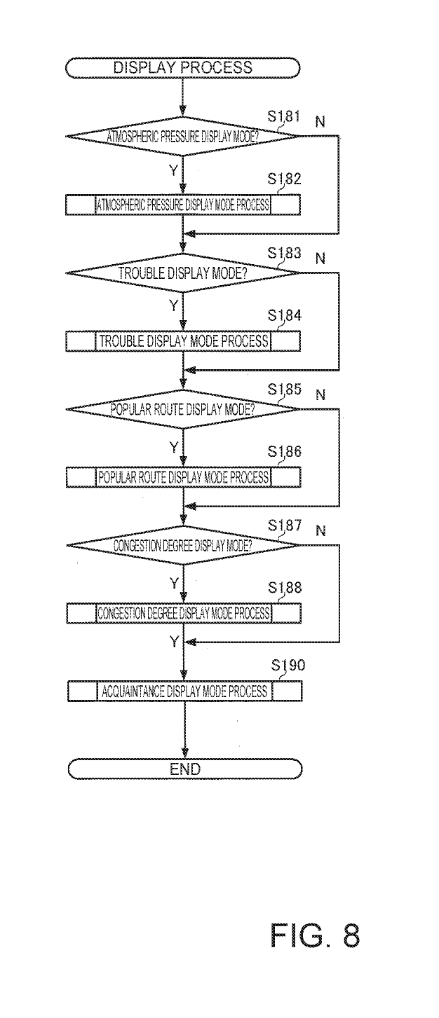

FIG. 8 is a flowchart for describing the display process carried out by the processor 120. The display process is carried out in accordance with the display program 136. Each step of the display process will be sequentially described below.

Step S181: The processor 120 evaluates whether or not the display mode of the electronic apparatus 1 is the atmospheric pressure display mode. When a result of the evaluation shows that the display mode is the atmospheric pressure display mode (Y in step S181), the processor 120 proceeds to step S182, whereas when a result of the evaluation shows that the display mode is not the atmospheric pressure display mode (N in step S181), the processor 120 proceeds to step S183.

Step S182: The processor 120 carries out an atmospheric pressure display mode process. The atmospheric pressure display mode process will be described later in detail.

Step S183: The processor 120 evaluates whether or not the display mode of the electronic apparatus 1 is the trouble display mode. When a result of the evaluation shows that the display mode is the trouble display mode (Y in step S183), the processor 120 proceeds to step S184, whereas when a result of the evaluation shows that the display mode is not the trouble display mode (N in step S183), the processor 120 proceeds to step S185.

Step S184: The processor 120 carries out a trouble display mode process. The trouble display mode process will be described later in detail.

Step S185: The processor 120 evaluates whether or not the display mode of the electronic apparatus 1 is the popular route display mode. When a result of the evaluation shows that the display mode is the popular route display mode (Y in step S185), the processor 120 proceeds to step S186, whereas when a result of the evaluation shows that the display mode is not the popular route display mode (N in step S185), the processor 120 proceeds to step S187.

Step S186: The processor 120 carries out a popular route display mode process. The popular route display mode process will be described later in detail.

Step S187: The processor 120 evaluates whether or not the display mode of the electronic apparatus 1 is the congestion degree display mode. When a result of the evaluation shows that the display mode is the congestion degree display mode (Y in step S187), the processor 120 proceeds to step S188, whereas when a result of the evaluation shows that the display mode is not the congestion degree display mode (N in step S187), the processor 120 proceeds to step S190.

Step S188: The processor 120 carries out a congestion degree display mode process and proceeds to step S190. The congestion degree display mode process will be described later in detail.

Step S190: The processor 120 carries out an acquaintance display mode process. The acquaintance display mode process will be described later in detail.

The order in which the steps in FIG. 8 are carried out can be changed as appropriate. For example, the points of time at which steps S181 and S182, steps S183 and S184, steps S185 and S186, and steps S187 and S188 are carried out can be swapped with each other.

The atmospheric pressure display mode, the trouble display mode, the popular route display mode, the congestion degree display mode, and the acquaintance display mode are summarized in the following table.

TABLE 1

| | | | | Examples of |
|---|---|---|---|---|
| | | Information | | how user uses |
| Name of | | used in the | Displayed | displayed |
| display mode | Purpose | mode | contents | contents |
| Atmospheric | Share weather | Position | Atmospheric | User can |
| pressure | information | coordinates | pressure | judge |
| | along route and | Atmospheric | measured at each | tendency of |
| | therearound | pressure | point on user's | weather. |
| | | Time | route is | |
| | | Route data | chronologically | |
| | | Other | displayed. | |
| | | factors | | |
| Trouble | Share | Position | Display point | User can |
| | information on | coordinates | where another | judge |
| | route point | Time | user who has | possibility |
| | where trouble | Route data | traveled user's | of |
| | has occurred | Trouble flag | route has | occurrence |
| | | Other | encountered | of some |
| | | factors | trouble | trouble on |
| | | | (changed route) | route. |
| Popular | Share | Position | Display | User is |
| route | information on | coordinates | frequency of use | notified of |
| | the number of | Time | of user's route | popularity |
| | users who have | Route data | on a partial | and can use |
| | used route | Other | route basis | popularity |
| | | factors | | for making |
| | | | | decision of |
| | | | | route |
| | | | | selection. |
| Congestion | Share | Position | Display | User can |
| degree | information on | coordinates | population | grasp degree |
| | degree of | Time | density | of |
| | congestion on | Route data | representing | congestion |
| | route | Other | the number of | at each point |
| | | factors | other users on | on route and |
| | | | user's route | decide to |
| | | | | change |
| | | | | route, rest |
| | | | | place, and |
| | | | | others. |
| Acquaintance | Grasp specific | Position | Display | User can |
| | acquaintance's | coordinates | movement locus | grasp |
| | action | Time | of specific user | specific |
| | | Route data | among other | user's |
| | | Serial ID | users who have | action. |
| | | Other | traveled user's | |
| | | factors | route | |

### 1-5-2-1. Atmospheric Pressure Display Mode

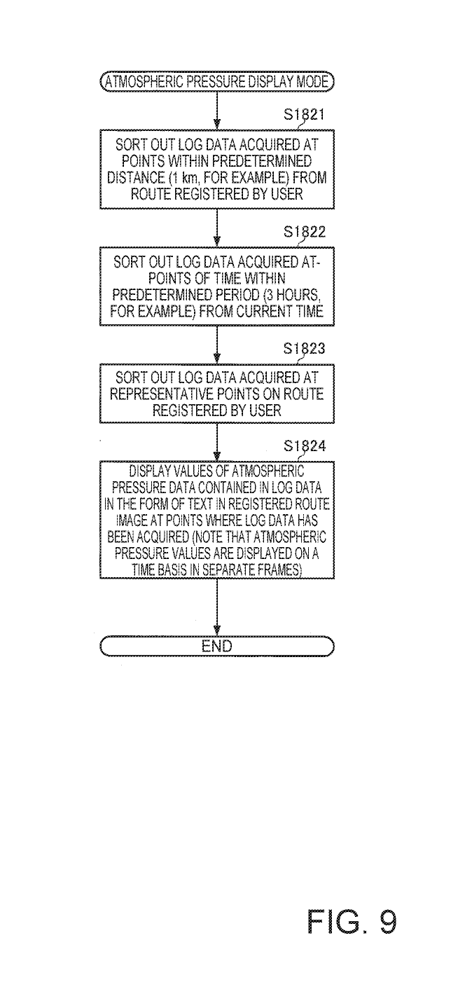

FIG. 9 is a flowchart for describing the atmospheric pressure display mode process carried out by the processor 120. The atmospheric pressure display mode process is carried out in accordance with the atmospheric pressure display mode program 1371. Each step of the process will be sequentially described below.

Step S1821: The processor 120 refers to the mountain climbing plan data 132 to recognize the coordinates of the positions of the points that form the user's route (user's route includes not only planned route but also reserve route). The processor 120 then searches the mountain climbing log data 133 on the basis of the position coordinates to select log data acquired (measured) in the vicinity of the user's route from a plurality of sets of log data in the mountain climbing log data 133.

For example, the processor 120 refers to the coordinates of each of the positions in each of the plurality of sets of log data, calculates the distance from the coordinates of the position in the log data to the coordinates of the position of each of the points that form the user's route, sets log data in which the minimum of the calculated distances is smaller than or equal to a predetermined threshold (1 km, for example) to be log data to be sorted out, and excludes log data in which the minimum of the calculated distances is greater than the predetermined threshold from the log data to be sorted out.

Sorting log data out on the basis of the distance from the user's route as described above allows exclusion of log data unnecessary for the user who is traveling along the route.

Step S1822: The processor 120 sorts out log data recently acquired (measured) from the sorted-out log data.

For example, the processor 120 refers to each point of time in each of the sorted-out sets of log data, calculates the elapsed period from the time in the log data to the current time, sets log data in which the elapsed period is smaller than or equal to a predetermined threshold (3 hours, for example) to be log data to be sorted out, and excludes log data in which the elapsed period is greater than the predetermined threshold from the log data to be sorted out.

Since mountain weather tends to change, too old log data is not informative for weather prediction. Further, assuming the period for which a typical mountain climber walks per day to be 6 hours, one-way walking period is 3 hours. Therefore, sorting log data out in accordance with whether or not the elapsed period to the current time is longer than 3 hours, as in the present step, allows exclusion of log data unnecessary for weather prediction. (It is, however, noted that when the user desires to minimize the number of sets of log data to be sorted out, only the latest log data may be set to be log data to be sorted out, and the other log data may be excluded from those to be sorted out.)

Step S1823: The processor 120 sorts out log data acquired (measured) at representative points on the user's route or at points in the vicinity thereof from the sorted-out sets of log data. The term “representative points on a route” are, for example, individual division points that divide the user's route into partial routes each having a predetermined distance (1 km, for example) or individual lattice points that divide an area to which the user's route belongs into a plurality of blocks each having a predetermined size (area whose one side is 1 km in length, for example).

Sorting log data out in accordance with the distance from each of the uniformly distributed representative points as described above allows uniform distribution of the log data (that is, prevents spatial unbalance of log data).

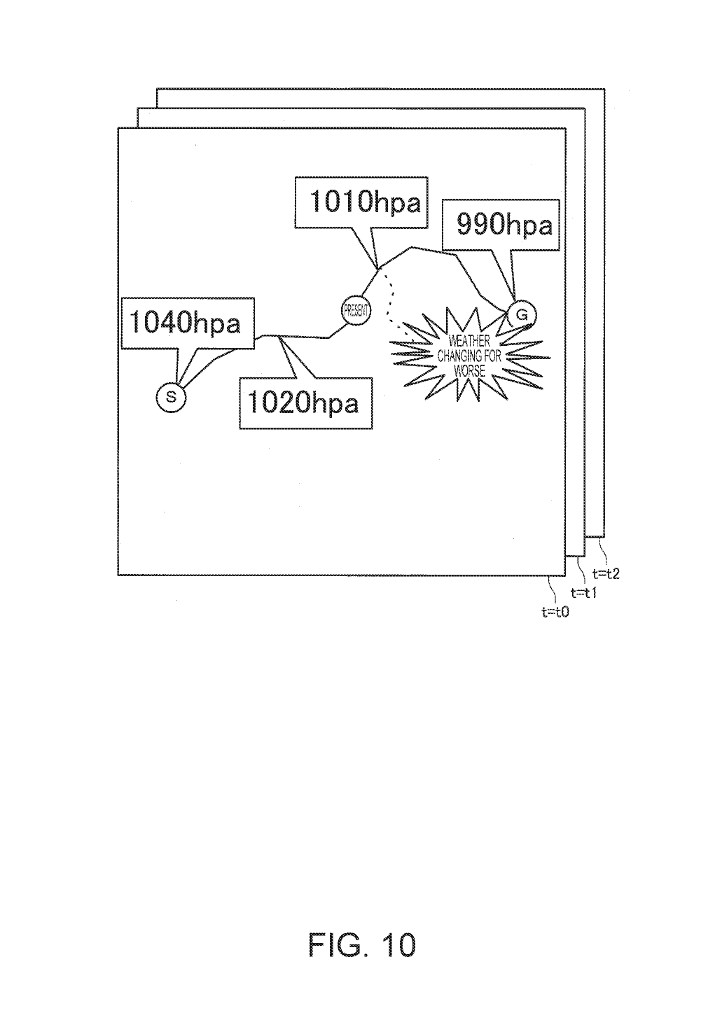

Step S1824: The processor 120 causes the display 170 to display an image showing the user's route and an image showing atmospheric pressure values in the sorted-out log data (example of data representing atmospheric pressure), as shown in FIG. 10, and terminates the atmospheric pressure display mode process.

For example, the processor 120 creates a zigzag line image showing the user's route on the basis of the coordinates of the positions of the points on the user's route and provides the display 170 with the zigzag line image to cause the display 170 to display the user's route.

Further the processor 120 creates, for example, a text image showing the atmospheric pressure values in the sorted-out log data (example of information on atmospheric pressure at two or more points) and provides the display 170 with the text image to cause the display 170 to display the atmospheric pressure values in the log data. It is noted that on the display screen of the display 170, the locations where the atmospheric pressure values in the log data are displayed are points where the log data were measured. The points are those where the user associated with the log data was present when the log data were measured and which are expressed by the position coordinates in the log data.

The processor 120 in the present step may display the atmospheric pressure values on a time basis in separate frames. In FIG. 10, the frames labeled with t=t0, t=t1, and t=t2 indicate frames at different points of time.

The processor 120 in the present step may give display priority to the frame acquired at the latest time over the other frames, as shown in FIG. 10.

The processor 120 in the present step may further prompt the user to perform predetermined operation of shifting the frame forward or predetermined operation of shifting the frame backward to switch the frame displayed on the display 170 to another in a chronological order or in a reversed chronological order in accordance with the two types of predetermined operation.

When there is a point where the atmospheric pressure lowers at a speed greater than a predetermined threshold, the processor 120 in the present step may cause the display 170 to perform call-for-attention display (display “weather changing for worse” or any other text image), as shown in FIG. 10. The call-for-attention display can notify the user of a possibility of start of rainfall or any other change in weather in the near future.

Further, the processor 120 in the present step may express the planned route with a solid line and the reserve route with a dotted line, as shown in FIG. 10.

The processor 120 in the present step may give the point of departure (start point) of the planned route a mark “S” that stands for start, give the destination (goal point) of the planned route a mark “G” that stands for goal, and give the point where the user is present (present point) a mark “Present” that stands for the present, as shown in FIG. 10.

In FIG. 10, the contour of the display screen of the display 170 has a rectangular shape, but the contour of the display screen does not necessarily have a rectangular shape. The contour of the display screen is desirably selected as appropriate in accordance with the contour of the display 170 and other factors.

The order in which the steps in FIG. 9 are carried out can be changed as appropriate. For example, the points of time at which steps S1821, S1822, and S1823 are carried out can be swapped with each other.

### 1-5-2-2. Trouble Display Mode

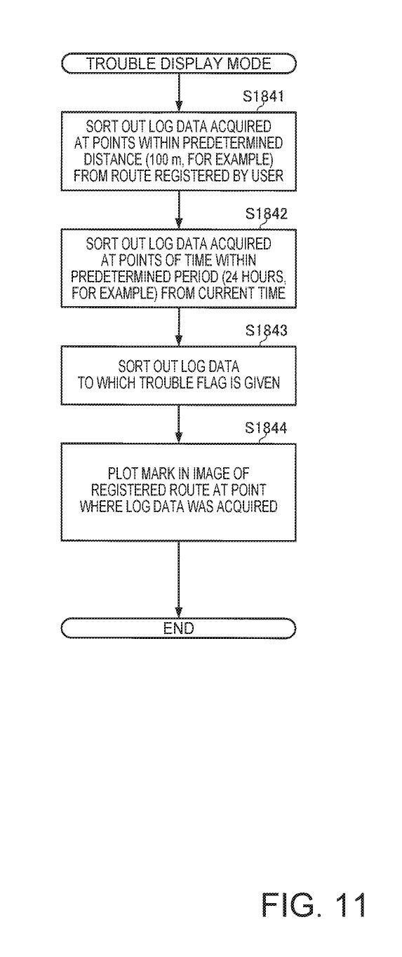

FIG. 11 is a flowchart for describing the trouble display mode process carried out by the processor 120. The trouble display mode process is carried out in accordance with the trouble display mode program 1372. Each step of the process will be sequentially described below.

Step S1841: The processor 120 refers to the mountain climbing plan data 132 to recognize the coordinates of the positions of the points that form the user's route (user's route includes not only planned route but also reserve route). The processor 120 then searches the mountain climbing log data 133 on the basis of the position coordinates to sort out log data acquired (measured) in the vicinity of the user's route from a plurality of sets of log data in the mountain climbing log data 133.

For example, the processor 120 refers to the coordinates of each of the positions in each of the plurality of sets of log data, calculates the distance from the coordinates of the position in the log data to the coordinates of the position of each of the points that form the user's route, sets log data in which the minimum of the calculated distances is smaller than or equal to a predetermined threshold (100 m, for example) to be log data to be sorted out, and excludes log data in which the minimum of the calculated distances is greater than the predetermined threshold from the log data to be sorted out.

To allow the user to learn the situation of the route, troubles at points remote from the route are not informative. Sorting log data out in accordance with whether or not the distance from the route is longer than 100 m allows exclusion of log data unnecessary for the user to learn the situation of the route.

Step S1842: The processor 120 sorts out log data recently acquired (measured) from the sorted-out log data.

For example, the processor 120 refers to each point of time in each of the sorted-out sets of log data, calculates the elapsed period from the point of time in the log data to the current time, sets log data in which the elapsed period is smaller than or equal to a predetermined threshold (24 hours, for example) to be log data to be sorted out, and excludes log data in which the elapsed period is greater than the predetermined threshold from the log data to be sorted out.

A trouble that occurs on a mountain climbing route is not quickly solved in many cases. Even a relatively old trouble is therefore likely to be informative in learning the situation of the route. Therefore, sorting log data out in accordance with whether or not the elapsed period to the current time is longer than 24 hours, as in the present step, is considered to allow extraction of log data sets the number of which is large enough to learn the situation of the route.

Step S1843: The processor 120 sorts out log data to which the trouble flag is given (example of data representing point where trouble has occurred) from the sorted-out sets of log data.

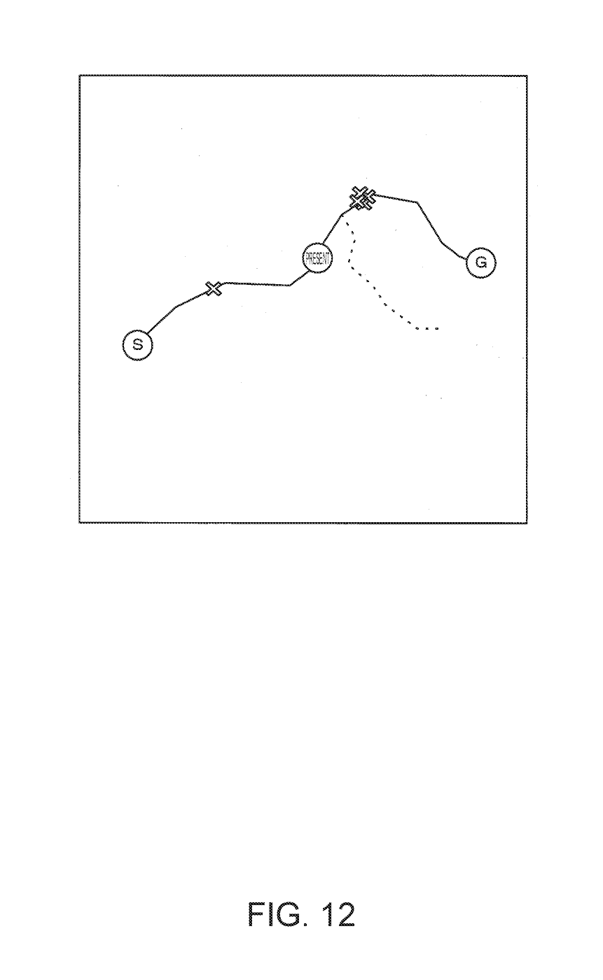

Step S1844: The processor 120 causes the display 170 to display an image showing the user's route and the X-shaped mark representing the locations where the sorted-out log data were measured, as shown in FIG. 12, and terminates the trouble display mode process.

For example, the processor 120 creates a zigzag line image showing the user's route on the basis of the coordinates of the positions of the points on the user's route and provides the display 170 with the zigzag line image to cause the display 170 to display the user's route.

Further the processor 120 creates, for example, an X-shaped mark image (example of information on trouble occurrence frequency distribution) and provides the display 170 with the image to cause the display 170 to plot the X-shaped mark. It is noted that on the display screen of the display 170, the location where the X-shaped mark is plotted is the point where each of the sorted-out sets of log data was measured. The point is a point where the user was present when the log data was measured and which is expressed by the corresponding position coordinates in the log data.

When the locations where two or more sets of log data were measured coincide with one another, the processor 120 may intentionally shift the locations where the two or more marks are plotted from one another instead of plotting the two or more marks at the same location or may plot one mark having a size increased in accordance with the degree of the coincidence. The reason for this is that it is more important to notify the user of the trouble occurrence frequency than notifying the user of the exact location where troubles have occurred.

The user can therefore consider a point where a large number of marks are plotted (or a large mark is plotted) to be a point where troubles occur at a high frequency. On the other hand, the user can consider a point where only one mark is plotted to be a point where troubles occur at a low frequency. Further, the user can consider a point where no mark is plotted to be a point where no trouble has occurred. The information on the frequency allows the user to predict a rough situation of the route surface at each point on the route (for example, whether or not the route is passable).

When a route selected after a trouble has occurred (after route has been changed) can be distinguished from the routes in the log data, the processor 120 in the present step may display the selected route in an enhanced form. Examples of the enhanced display include color-based enhanced display, brightness-based enhanced display, and blinking-based enhanced display.

The processor 120 in the present step may express the planned route with a solid line and the reserve route with a dotted line, as shown in FIG. 12.

The processor 120 in the present step may give the point of departure (start point) of the planned route a mark “S” that stands for start, give the destination (goal point) of the planned route a mark “G” that stands for goal, and give the point where the user is present (present point) a mark “Present” that stands for the present, as shown in FIG. 12.

In FIG. 12, the contour of the display screen of the display 170 has a rectangular shape, but the contour of the display screen does not necessarily have a rectangular shape. The contour of the display screen is desirably selected as appropriate in accordance with the contour of the display 170 and other factors.

The order in which the steps in FIG. 11 are carried out can be changed as appropriate. For example, the points of time at which steps S1841, S1842, and S1843 are carried out can be swapped with each other.

1-5-2-3. Popular Route Display Mode

FIG. 13 is a flowchart for describing the popular route display mode process carried out by the processor 120. The popular route display mode process is carried out in accordance with the popular route display mode program 1373. Each step of the process will be sequentially described below.

Step S1861: The processor 120 refers to the mountain climbing plan data 132 to recognize the coordinates of the positions of the points that form the user's route (user's route includes not only planned route but also reserve route). The processor 120 then searches the mountain climbing log data 133 on the basis of the position coordinates to sort out log data acquired (measured) in the vicinity of the user's route from a plurality of sets of log data in the mountain climbing log data 133.

For example, the processor 120 refers to the coordinates of each of the positions in each of the plurality of sets of log data, calculates the distance from the coordinates of the position in the log data to the coordinates of the position of each of the points that form the user's route, sets log data in which the minimum of the calculated distances is smaller than or equal to a predetermined threshold (100 m, for example) to be log data to be sorted out, and excludes log data in which the minimum of the calculated distances is greater than the predetermined threshold from the log data to be sorted out.

Sorting log data out in accordance with the distance from the user's route as described above allows exclusion of log data unnecessary for the user who is traveling along the route.

Step S1862: The processor 120 sorts out log data recently acquired (measured) from the sorted-out log data.

For example, the processor 120 refers to each point of time in each of the sorted-out sets of log data, calculates the elapsed period from the point of time in the log data to the current time, sets log data in which the elapsed period is smaller than or equal to a predetermined threshold (24 hours, for example) to be log data to be sorted out, and excludes log data in which the elapsed period is greater than the predetermined threshold from the log data to be sorted out.

In this process, the user desires to grasp the popularity of a route. Even relatively old information on use of the route is therefore possibly informative for learning the popularity of the route. Therefore, sorting log data out in accordance with whether or not the elapsed period to the current time is longer than 24 hours, as in the present step, is considered to allow extraction of log data sets the number of which is large enough to learn the popularity of the route.

Step S1863: The processor 120 uses the serial ID to classify the sorted-out log data on a user basis. The processor 120 further calculates each user's movement locus on the basis of the position coordinates and time in the log data (example of data representing information provider's movement locus) associated with the user. The processor 120 still further calculates each user's travel route on the basis of the user's movement locus. The term “user's travel route” is an existing route closest to the user's movement locus.

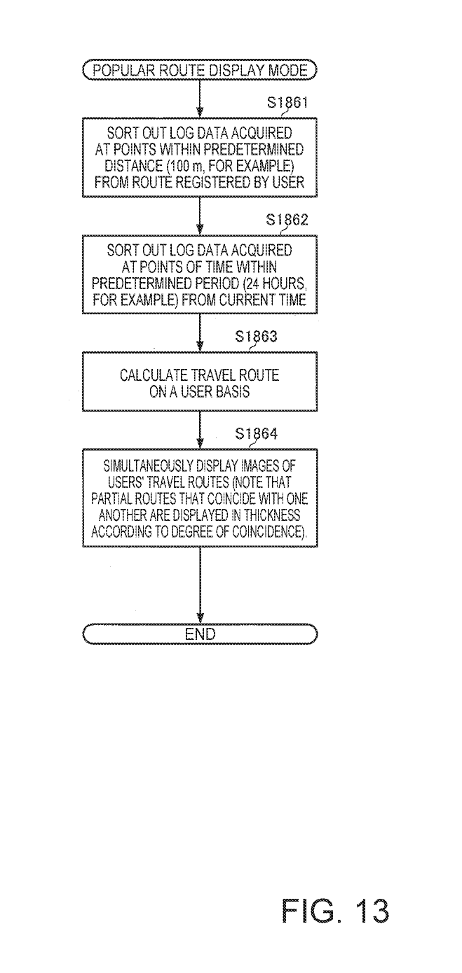

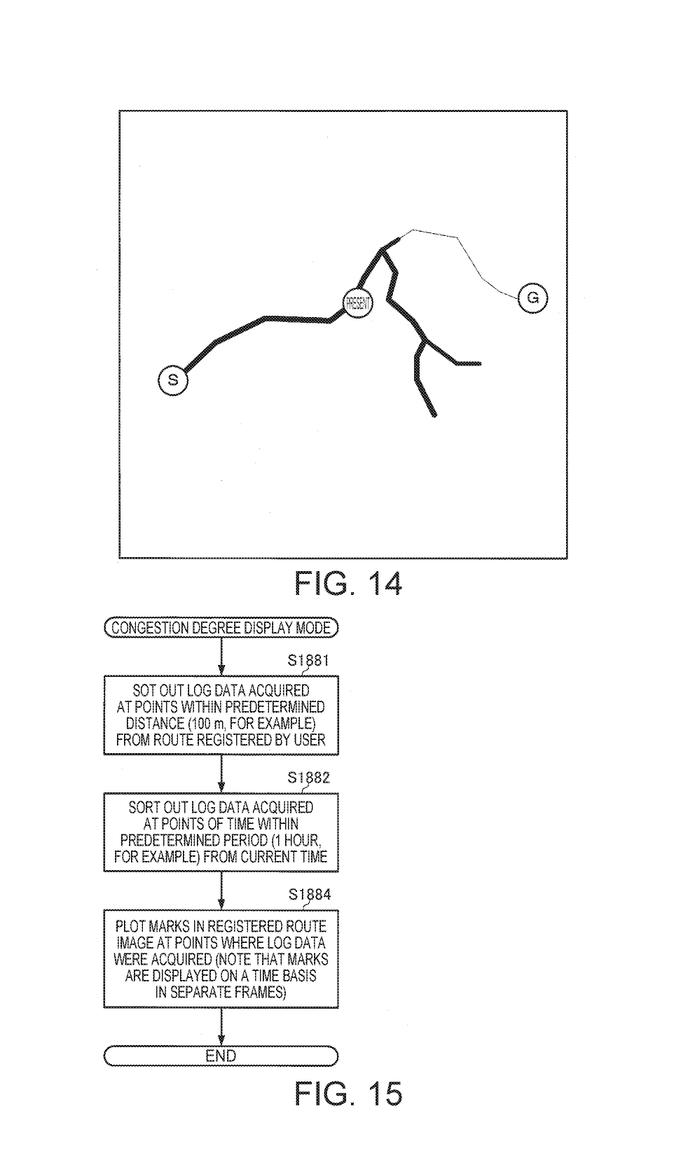

Step S1864: The processor 120 causes the display 170 to display an image showing each user's travel route (example of information on the frequency of use of at least a partial segment), as shown in FIG. 14, and terminates the popular route display process.

It is noted that when at least part of one or more users' travel routes coincides with at least part of another user's travel route, the processor 120 displays the portions that coincide with each other (partial route) in a thickness according to the degree of the coincidence.

The user can therefore learn the frequency of use of each route (or partial route), that is, the popularity of each route in the form of the thickness of the route (or partial route).

When it is difficult to express the frequency of use in the form of thickness of a route (for example, when the display 170 is small), the processor 120 in the present step may express the frequency of use, for example, in the form of a route line type (dotted line, solid line) or a route line color.

The processor 120 in the present step may plot, instead of displaying each user's travel route, a mark at a point where each of the sorted-out sets of log data was measured (that is, point where user was present at the time of measurement).

When the points where two or more users were present coincide with one another, the processor 120 may intentionally shift the locations where the two or more marks are plotted from one another instead of plotting the two or more marks at the same location or may plot one mark having a size increased in accordance with the degree of the coincidence. The reason for this is that it is more important to notify the user of the number of users, which is at least two, than notifying the user of the exact location where the two or more users were present.

Therefore, on the basis of the thickness or any other attribute of a displayed route (or partial route), the user can learn the popularity of the route. The information on the popularity allows the user, for example, to select an unpopular route and travel along it for comfortable congestion-free mountain climbing.

The processor 120 in the present step may give the point of departure (start point) of the planned route a mark “S” that stands for start, give the destination (goal point) of the planned route a mark “G” that stands for goal, and give the point where the user is present (present point) a mark “Present” that stands for the present, as shown in FIG. 14.

In FIG. 14, the contour of the display screen of the display 170 has a rectangular shape, but the contour of the display screen does not necessarily have a rectangular shape. The contour of the display screen is desirably selected as appropriate in accordance with the contour of the display 170 and other factors.

The order in which the steps in FIG. 13 are carried out can be changed as appropriate. For example, the points of time at which steps S1861 and S1862 are carried out can be swapped with each other.

### 1-5-2-4. Congestion Degree Display Mode

FIG. 15 is a flowchart for describing the congestion degree display mode process carried out by the processor 120. The congestion degree display mode process is carried out in accordance with the congestion degree display mode program 1374. Each step of the process will be sequentially described below.

Step S1881: The processor 120 refers to the mountain climbing plan data 132 to recognize the coordinates of the positions of the points that form the user's route (user's route includes not only planned route but also reserve route). The processor 120 then searches the mountain climbing log data 133 on the basis of the position coordinates to sort out log data acquired (measured) in the vicinity of the user's route from a plurality of sets of log data in the mountain climbing log data 133.

For example, the processor 120 refers to the coordinates of each of the positions in each of the plurality of sets of log data, calculates the distance from the coordinates of the position in the log data to the coordinates of the position of each of the points that form the user's route, sets log data in which the minimum of the calculated distances is smaller than or equal to a predetermined threshold (100 m, for example) to be log data to be sorted out, and excludes log data in which the minimum of the calculated distances is greater than the predetermined threshold from the log data to be sorted out.

Sorting log data out in accordance with the distance from the user's route as described above allows exclusion of log data unnecessary for the user who is traveling along the route.

Step S1882: The processor 120 selects log data recently acquired (measured) from the sorted-out log data.

For example, the processor 120 refers to each point of time in each of the sorted-out sets of log data, calculates the elapsed period from the point of time in the log data to the current time, and excludes log data in which the elapsed period is greater than a predetermined threshold from the log data to be sorted out.

In this process, the user desires to grasp the degree of congestion. Therefore, sorting log data out in accordance with whether or not the elapsed period to the current time is longer than 1 hour, as in the present step, allows exclusion of log data unnecessary for learning a recent degree of congestion.

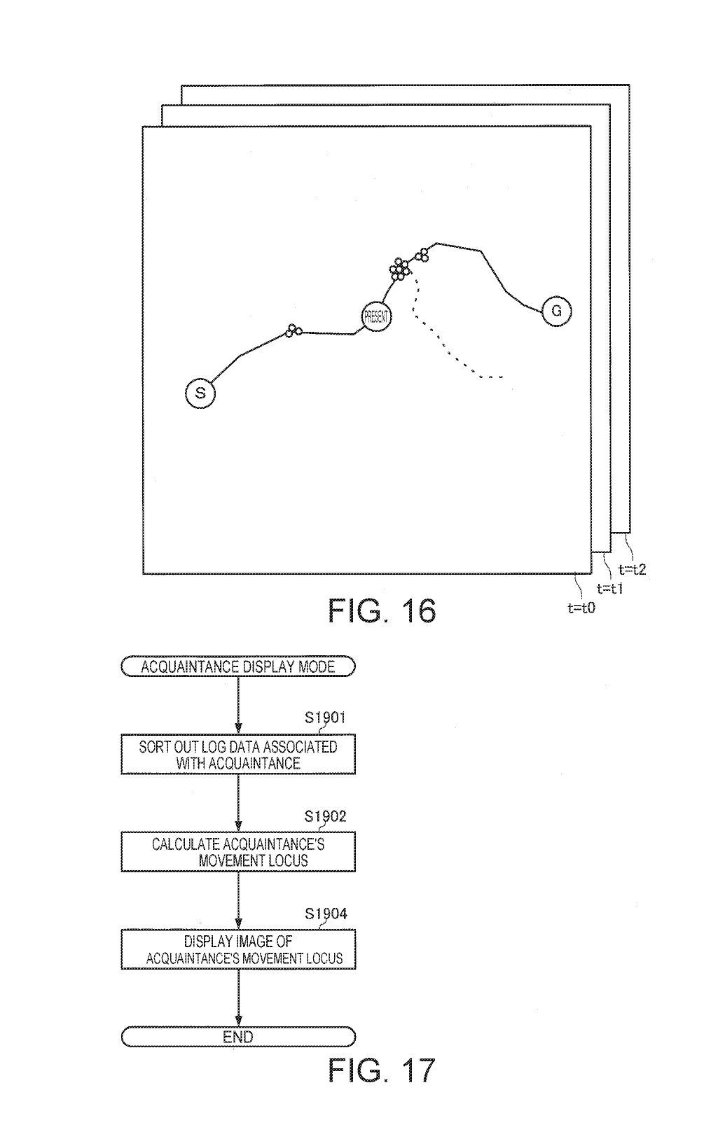

Step S1844: The processor 120 causes the display 170 to display an image showing the user's route and the circular mark representing the locations where the sorted-out log data (example of data representing points where information providers were present) were measured, as shown in FIG. 16, and terminates the congestion degree display process.

For example, the processor 120 creates a zigzag line image showing the user's route on the basis of the coordinates of the positions of the points on the user's route and provides the display 170 with the zigzag line image to cause the display 170 to display the user's route.

Further the processor 120 creates, for example, a circular mark image (example of information on congestion degree distribution) and provides the display 170 with the image to cause the display 170 to plot the circular mark. It is noted that on the display screen of the display 170, the location where the circular mark is plotted is the point where each of the sorted-out sets of log data was measured. The point is a point where the user was present when the log data was measured and which is expressed by the corresponding position coordinates in the log data.

When the points where two or more users were present coincide with one another, the processor 120 may intentionally shift the locations where the two or more marks are plotted from one another instead of plotting the two or more marks at the same location or may plot one mark having a size increased in accordance with the degree of the coincidence. The reason for this is that it is more important to notify the user of the number of users, which is at least two, than notifying the user of the exact location where the two or more users were present.

The user can therefore consider a point where a large number of marks are plotted (or a large mark is plotted) to be a point where the degree of congestion is high. On the other hand, the user can consider a point where only one mark is plotted to be a point where the degree of congestion is low. Further, the user can consider a point where no mark is plotted to be a point where there is no congestion. The information on the degree of congestion allows the user to learn the degree of congestion at each point on the route. The user can therefore, for example, select a route where the degree of congestion is low and travel along it for comfortable congestion-free mountain climbing.

The user can further grasp the degree of congestion at a variety of event points (such as noted place, rest place, mountain lodge, and summit of mountain) on the route on the basis of the mark density distribution. The user can therefore select a point where the degree of congestion is low as a rest point to ensure a sufficient rest space. For example, when rest places for lunch are present at points 1 km and 2 km ahead of the present point, and when the degree of congestion at the rest place 1 km ahead is high, the user can, for example, decide to walk a little more to use the rest place 2 km ahead.

The processor 120 in the present step may display images with marks plotted on a time basis in separate frames. In FIG. 16, the frames labeled with t=t0, t=t1, and t=t2 indicate frames at different points of time.

The processor 120 in the present step may give display priority to the frame acquired at the latest time over the other frames, as shown in FIG. 16.

The processor 120 in the present step may further prompt the user to perform predetermined operation of shifting the frame forward or predetermined operation of shifting the frame backward to switch the frame displayed on the display 170 to another in a chronological order or in a reversed chronological order in accordance with the two types of predetermined operation.

Further, the processor 120 in the present step may express the planned route with a solid line and the reserve route with a dotted line, as shown in FIG. 16.

The processor 120 in the present step may give the point of departure (start point) of the planned route a mark “S” that stands for start, give the destination (goal point) of the planned route a mark “G” that stands for goal, and give the point where the user is present (present point) a mark “Present” that stands for the present, as shown in FIG. 16.

In FIG. 16, the contour of the display screen of the display 170 has a rectangular shape, but the contour of the display screen does not necessarily have a rectangular shape. The contour of the display screen is desirably selected as appropriate in accordance with the contour of the display 170 and other factors.

The order in which the steps in FIG. 15 are carried out can be changed as appropriate. For example, the points of time at which steps S1881 and S1882 are carried out can be swapped with each other.

### 1-5-2-5. Acquaintance Display Mode

FIG. 17 is a flowchart for describing the acquaintance display mode process carried out by the processor 120. The acquaintance display mode process is carried out in accordance with the acquaintance display mode program 1375.

The term “acquaintance” is another user who carries another electronic apparatus 1 and is a mountain climber who allows the user's electronic apparatus 1 to grasp his/her action, and has a plan for climbing on the same date and along the same route as the user.

The acquaintance, however, possibly strays from the user in the course of the mountain climbing. In preparation for such a possibility, the user of the electronic apparatus 1 causes the user's electronic apparatus 1 to communicate with the acquaintance's electronic apparatus at least once before the mountain climbing so that the electronic apparatus 1 recognizes (memorizes) the serial ID of the acquaintance's electronic apparatus. In the electronic apparatus 1, the serial ID is memorized, for example, in the nonvolatile RAM in the memory 130. Each step of the acquaintance display process will be sequentially described below.

Step S1901: The processor 120 searches the mountain climbing log data 133 on the basis of the serial ID of the acquaintance's electronic apparatus to sort out log data associated with the acquaintance from a plurality of sets of log data (example of data representing information providers' movement locus) stored in the mountain climbing log data 133.

Step S1902: The processor 120 calculates the acquaintance's movement locus on the basis of the position coordinates and time in the log data associated with the acquaintance.

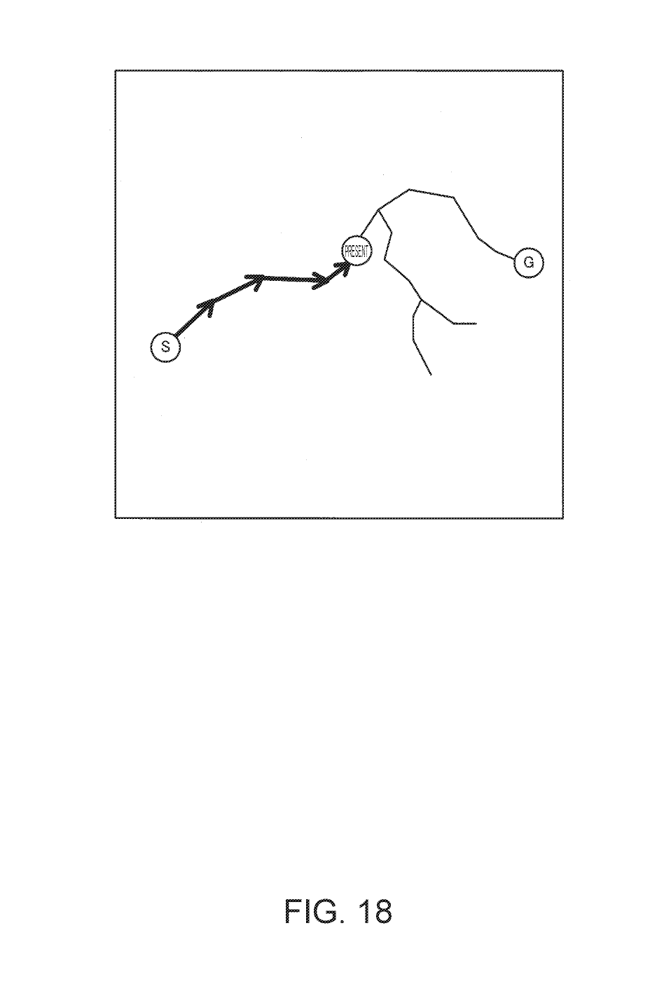

Step S1904: The processor 120 causes the display 170 to display an image (zigzag line image or curved line image) showing the acquaintance's movement locus (example of information on specific information provider's movement locus), as shown in FIG. 18, and terminates the acquaintance display process.

The processor 120 in the present step may give segments that form the movement locus displayed on the display 170 arrow marks indicating the direction in which the acquaintance is traveling. The thus given arrow marks allow the user to learn how the acquaintance is traveling. The direction in which the acquaintance is traveling can be determined in the course of calculating the acquaintance's movement locus.

The user can therefore grasp the acquaintance's action even when the user and the acquaintance act separately from each other for some reasons or when the acquaintance strays from the user.

The processor 120 in the present step may give the point of departure (start point) of the planned route a mark “S” that stands for start, give the destination (goal point) of the planned route a mark “G” that stands for goal, and give the point where the acquaintance is present (present point) a mark “Present” that stands for the present, as shown in FIG. 18.

In FIG. 18, the contour of the display screen of the display 170 has a rectangular shape, but the contour of the display screen does not necessarily have a rectangular shape. The contour of the display screen is desirably selected as appropriate in accordance with the contour of the display 170 and other factors.

The order in which the steps in FIG. 17 are carried out can be changed as appropriate. For example, the points of time at which steps S1901 and S1902 are carried out can be swapped with each other.

### 2. Supplementary Description of Embodiment

The processor 120 in the embodiment described above causes the display 170 to display atmospheric pressure values (one type of atmospheric pressure distribution) at two or more points as the weather information along a route (see FIG. 10). The processor 120 may instead display at least one of temperature distribution, humidity distribution, and ultraviolet ray distribution as the weather information along a route in place of or in addition to the atmospheric pressure distribution.

The temperature distribution is drawn by using the output from the temperature sensor 160 (temperature data). The humidity distribution is drawn by using the output from a humidity sensor that is not shown (humidity data). The ultraviolet ray distribution is drawn by using the output from an ultraviolet ray sensor that is not shown (ultraviolet ray data).

The information terminal in the embodiment described above, when it prompts the user to specify a route, may prompt the user to specify a specific shape of the route (positional relationship among a plurality of points on the route) or may prompt the user to specify one of existing routes made open to the public over the network 3 or one of existing routes made open by the network server 4 to the user.

At least part of two or more of the above-mentioned processes serially carried out by the processor 120 may be carried out in parallel to one another. For example, the processes in steps S12 to S14 and the processes in steps S15 to S17 may be carried out in parallel to each other.

On the other hand, at least part of two or more the above-mentioned processes carried out in parallel to each other by the processor 120 may be serially carried out.

In the embodiment described above, in the electronic apparatus, at least one of the plurality of display modes described above may be omitted, and at least one of the display modes only needs to be incorporated. Instead, arbitrary two or more of the plurality of display modes described above may be incorporated in the electronic apparatus.

In the embodiment described above, at least part of the functions of the electronic apparatus 1 may be incorporated in the network server 4. For example, the function of sorting out necessary log data from a large number of sets of log data may be incorporated in the network server 4. Further, the function of retaining a large number of sets of log data may be incorporated in the network server 4 or in the electronic apparatus 1.

In a case where the network server 4 and the electronic apparatus 1 both retain the log data and the electronic apparatus 1 is successfully connected to the network server 4, the log data retained in the network server 4 and the log data retained in the electronic apparatus 1 may be compared with or added to each other to allow the electronic apparatus 1 or the network server 4 to generate more reliable information (information closer to real-time information, for example) and provide the user with the generated information.

In the present embodiment, the electronic apparatus 1 carried by the user directly communicates with the network server 4. Instead, the information terminal carried by the user may be interposed between the electronic apparatus 1 and the network 3. In this case, the communication device 190B of the electronic apparatus 1 is not essential.

In the present embodiment, part or entirety of the functions of the network server 4 may be incorporated in the information terminal or the electronic apparatus 1, part or entirety of the functions of the electronic apparatus 1 may be incorporated in the network server 4, or part or entirety of the functions of the information terminal may be incorporated in the electronic apparatus 1 or the network server 4.

The processor 120 in the embodiment described above uses the output from the GPS sensor 110 to calculate the coordinates of the position of the electronic apparatus 1 and may instead use the output from at least one of the GPS sensor 110, the terrestrial magnetism sensor 111, the atmospheric pressure sensor 112, the acceleration sensor 113, and the angular velocity sensor 114 or a combination of two or more of the outputs therefrom. (That is, any of the GPS sensor 110, the terrestrial magnetism sensor 111, the atmospheric pressure sensor 112, the acceleration sensor 113, and the angular velocity sensor 114 can be an example of a position sensor.)

### 3. Outline of Embodiment

(1) The electronic apparatus 1 according to the present embodiment is carried L1 by a user and includes a receiver (communication devices 190A and 190B) that receives, during a period (period for which information collection process is carried out) for which the user is traveling along a route determined in advance (such as planned route, reserve route, and existing route), actually measured data (log data) acquired by electronic apparatus of information providers (other users) who are traveling along the route and a notifier (display 170) that notifies the user of information on the route (FIGS. 10, 12, 14, 16, and 18) on the basis of the plurality of sets of received actually measured data.

That is, the receiver collects the actually measured data on the route during the period for which the user is actually traveling along the route. The source from which the actually measured data is provided is the electronic apparatus of the information providers (other users) who are actually traveling along the route. It is therefore highly probable that a recent situation (including current situation) on the route has been reflected in the actually measured data. It is therefore considered that the notifier can notify the user of the recent situation (including current situation) of the route as the information on the route. Further, to receive the notification, the user only needs to travel along the route without particularly being aware of the information collection.

(2) The electronic apparatus 1 according to the present embodiment further includes a measurement device (such as GPS sensor 110, terrestrial magnetism sensor 111, atmospheric pressure sensor 112, acceleration sensor 113, angular velocity sensor 114, pulse sensor 115, and temperature sensor 116) that performs measurement during the period described above, the processor 120, which uses results of the measurement performed by the measurement device described above to generate the actually measured data, and a transmitter (communication devices 190A and 190B) that transmits the generated actually measured data during the period described above to an apparatus external to the electronic apparatus carried by the user.

That is, the measurement device and the processor generate the actually measured data, and the communication devices transmit the actually measured data to an external apparatus. The electronic apparatus 1 can therefore exchange the actually measured data with another electronic apparatus and share information therewith.

(3) In the electronic apparatus 1 according to the present embodiment, the transmitter transmits the generated actually measured data and the received actually measured data.

That is, the transmitter transmits not only the internally generated actually measured data but also the received actually measured data (actually measured data that are externally collected) to an external apparatus. The electronic apparatus 1 can therefore transmit actually measured data from a plurality of electronic apparatus to another electronic apparatus. Further, the electronic apparatus 1 possibly shares information with an electronic apparatus with which the electronic apparatus 1 does not directly exchange actually measured data.

(4) In the electronic apparatus 1 according to the present embodiment, the actually measured data contains data representing the atmospheric pressure, and the information on the route contains information on the atmospheric pressure at two or more points.

That is, the notifier notifies the user of the atmospheric pressure at the two or more points on the basis of the data representing the atmospheric pressure. The user can therefore grasp a rough weather condition on the route.

(5) In the electronic apparatus 1 according to the present embodiment, the actually measured data contains data representing points where troubles have occurred, and the information on the route contains information on trouble occurrence frequency distribution.

That is, the notifier notifies the user of the trouble occurrence frequency distribution on the basis of the data representing points where troubles have occurred. The user can therefore predict a rough situation at each point on the route (for example, whether or not the route is easily passable).

(6) In the electronic apparatus 1 according to the present embodiment, the actually measured data contains data representing the information providers' movement locus, and the information on the route contains information on the frequency of use of at least a partial segment of the route.

That is, the notifier notifies the user of the frequency of use of at least a partial segment of the route on the basis of the data on the route used for travel. The user can therefore learn the popularity of the notified segment of the route (popularity of each partial route).

(7) In the electronic apparatus 1 according to the present embodiment, the actually measured data contains data representing points where the information providers were present, and the information on the route contains information on congestion degree distribution.

That is, the notifier notifies the user of the congestion degree distribution on the basis of data on the points where the information providers were present. The user can therefore learn the degree of congestion at each point on the route.

(8) In the electronic apparatus 1 according to the present embodiment, the actually measured data contains data representing the information providers' movement locus, and the information on the route contains information on a specific information provider's (acquaintance's) movement locus.

The notifier therefore notifies the user of the specific information provider's movement locus on the basis of the data on the movement locus. The user can therefore grasp the specific information provider's action.

(9) In the electronic apparatus 1 according to the present embodiment, the distance over which the receiver can receive the actually measured data is roughly equal to the communication distance in short-distance wireless communication, for example, roughly equal to the distance between the user and an information provider who passes by the user at a point on the route.

That is, when the user who carries the electronic apparatus land an information provider so approach each other on the route as to be close enough to allow short-distance wireless communication (when they pass by each other), the receiver performs reception, whereas when the user and the information provider do not pass by each other, the receiver performs no reception. The receiver can therefore limit an information collection area to an area equal to the area to which the route belongs. The occurrence of a situation in which a large amount of information that does not relate to the route along which the user is traveling is undesirably collected along with necessary information can therefore be suppressed, unlike a case where long-distance communication and other types of communication are performed.

(10) The electronic apparatus 1 according to the present embodiment is attachable to the user's predetermined site.

The user can therefore perform a sports activity in a hands-free state.

(11) In the electronic apparatus 1 according to the present embodiment, the predetermined site is an armor a wrist.

The user can therefore use the electronic apparatus 1 as if it were, for example, a wristwatch.

(12) A system according to the present embodiment is a system including a first electronic apparatus carried by a first user (another user's electronic apparatus 1′) and a second electronic apparatus carried by a second user (the user's electronic apparatus 1), the first electronic apparatus including a measurement device that performs measurement during the period for which the first user is traveling along a route determined in advance, a processor that uses results of the measurement performed by the measurement device to generate actually measured data, and a transmitter that transmits the generated actually measured data during the period described above to an apparatus external to the first electronic apparatus and the second electronic apparatus including a receiver that receives the actually measured data transmitted from the first electronic apparatus during the period for which the second user is traveling along the route and a notifier that notifies the second user of information on the route on the basis of the received actually measured data.

Therefore, according to the system of the present embodiment, information can be shared between the first user and the second user who carry electronic apparatus of the same type and travel along the same route.

### 4. Other Variations

The invention is not limited to the embodiment described above, and a variety of variations are conceivable within the scope of the substance of the invention.

For example, the electronic apparatus 1 or the information terminal may be provided with known functions of a smartphone, for example, a camera function, a call function, and a communication function.

The electronic apparatus 1 or the information terminal may be further provided with another sensing function (such as humidity sensor) of sensing at least part of the user's motion or biological activity.

Examples of application of the electronic apparatus or the information terminal may include not only cross-country skiing, running, bicycling, and walking as well as mountain climbing but also sailing, trail running, paragliding, dogsledding, and robot flying.

The electronic apparatus 1 or the information terminal can be configured as a wrist-worn-type electronic apparatus, an earphone-type electronic apparatus, a finger-ring-type electronic apparatus, a pendant-type electronic apparatus, an electronic apparatus attached to a sport gear for use, a smartphone, a head mounted display (HMD), and a variety of other types of mobile information apparatus.

The electronic apparatus 1 or the information terminal may notify the user of information in the form of image display, audio, vibration, or any other type of action or a combination of at least two of the image display, audio, and vibration.

In the embodiment described above, a GPS (Global Positioning System) is used, and a global navigation satellite system (GNSS) or any other system may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAAS (Wide Area Augmentation System), EGNOS (European Geostationary-Satellite Navigation Overlay Service), or any other satellite-based augmentation system (SBAS) may be used as at least one of the satellite positioning systems.

The embodiment and the variations described above are presented by way of example, and the invention is not limited thereto. For example, the embodiment and any of the variations can be combined with each other as appropriate.

The invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effects as those provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. An electronic apparatus carried by a user, the electronic apparatus comprising:
a receiver that receives, during a period for which the user is traveling along a route determined in advance, actually measured data acquired by electronic apparatus of information providers who are traveling along the route; and
a notifier that notifies the user of information on the route on the basis of the received actually measured data.

2. The electronic apparatus according to claim 1, further comprising
a measurement device that performs measurement during the period;
a processor that uses results of the measurement performed by the measurement device to generate the actually measured data; and
a transmitter that transmits the generated actually measured data during the period to an apparatus external to the electronic apparatus carried by the user.

3. The electronic apparatus according to claim 2,
wherein the transmitter transmits the generated actually measured data and the received actually measured data.

4. The electronic apparatus according to claim 1,
wherein the actually measured data contains data representing atmospheric pressure, and
the information on the route contains information on atmospheric pressure at two or more points.

5. The electronic apparatus according to claim 1,
wherein the actually measured data contains data representing points where troubles have occurred, and
the information on the route contains information on trouble occurrence frequency distribution.

6. The electronic apparatus according to claim 1,
wherein the actually measured data contains data representing the information providers' movement locus, and
the information on the route contains information on frequency of use of at least a partial segment of the route.

7. The electronic apparatus according to claim 1,
wherein the actually measured data contains data representing points where the information providers were present, and
the information on the route contains information on congestion degree distribution.

8. The electronic apparatus according to claim 1,
wherein the actually measured data contains data representing the information providers' movement locus, and
the information on the route contains information on a specific information provider's movement locus.

9. The electronic apparatus according to claim 1,
wherein the distance over which the receiver can receive the actually measured data is roughly equal to a communication distance in short-distance wireless communication.

10. The electronic apparatus according to claim 1,
wherein the electronic apparatus is attachable to the user's predetermined site.

11. The electronic apparatus according to claim 10,
wherein the predetermined site is an arm or a wrist.

12. A system comprising a first electronic apparatus carried by a first user and a second electronic apparatus carried by a second user,
wherein the first electronic apparatus includes a measurement device that performs measurement during a period for which the first user is traveling along a route determined in advance,
a processor that uses results of the measurement performed by the measurement device to generate actually measured data, and
a transmitter that transmits the generated actually measured data during the period to an apparatus external to the first electronic apparatus, and
the second electronic apparatus includes
a receiver that receives the actually measured data transmitted from the first electronic apparatus during a period for which the second user is traveling along the route, and
a notifier that notifies the second user of information on the route on the basis of the received actually measured data.

13. An information notification method carried out by an electronic apparatus carried by a user, the method comprising:
receiving, during a period for which the user is traveling along a route determined in advance, actually measured data acquired by electronic apparatus of information providers who are traveling along the route; and
notifying the user of information on the route on the basis of the received actually measured data.
